(19) United States
(12) Patent Application Publication
(10) Pub. No.: US 2014/0341448 A1
(43) Pub. Date: Nov. 20, 2014

(54) DIVERGENT SENSING DEVICE AND METHOD OF MANUFACTURING THE SAME

(71) Applicant: MEI-YEN LEE, (US)

(72) Inventor: LI-KUO CHIU, TAIPEI CITY (TW)

(73) Assignee: Mei-Yen Lee, Hsin Chu (TW)

(21) Appl. No.: 14/277,453

(22) Filed: May 14, 2014

(30) Foreign Application Priority Data
May 20, 2013 (TW) 102117689

(51) Int. Cl. G06K 9/00

(52) U.S. Cl. CPC G06K 9/0002
USPC 382/124; 29/846; 29/850

(57) ABSTRACT

In a sensing device, sensing circuit cells are formed on a lower structure, an upper structure is disposed on the lower structure along a vertical direction, and divergent traces are formed in the upper structure and electrically connected to the sensing circuit cells, respectively. Each divergent trace comprises at least one horizontal extending portion and at least one vertical extending portion perpendicular to each other. Sensing electrode cells are formed in the upper structure and electrically connected to the divergent traces, respectively, and sense biometrics features of an organism to generate sensing signals, which are transmitted to the sensing circuit cells through the divergent traces. The sensing circuit cells processes the sensing signals to obtain output signals, respectively. A minimum distribution area covering the sensing circuit cells is smaller than or equal to a minimum distribution area covering the sensing electrode cells.

This application claims priority of No. 102117689 filed in Taiwan R.O.C. on May 20, 2013 under 35 USC 119, the entire content of which is hereby incorporated by reference.

### BACKGROUND OF THE INVENTION

1. Field of the Invention

The invention relates in general to a sensing device and a method of manufacturing the same, and more particularly to a divergent sensing device and a method of manufacturing the same, and the technology of applying the sensing device to fingerprint sensing, for example.

2. Related Art

A conventional non-optical fingerprint sensing device (e.g., electric field/capacitive, thermal sensing type, pressure sensing type fingerprint sensing device) must perform the sensing operations on the finger's textures, so the essential sensing surface area to be in contact with the finger has to be kept large enough, so that the sufficient sensing accuracy can be obtained. For example, an electric field/capacitive fingerprint sensor has sensing members arranged in an array, and the area occupied by these sensing members corresponds to the sensed area of the finger in a 1:1 manner. For example, in a fingerprint sensor with a resolution of 500 dpi, the pitch of the sensing members of the sensing array is equal to about 50 microns (um). Each sensing member comprises a sensing electrode and the corresponding sensing circuit therebelow, and is usually manufactured by integrating the two elements in a semiconductor integrated circuit (IC) manufacturing process, such as a complementary metal oxide semiconductor (CMOS) manufacturing process, wherein the top metal layer in the manufacturing process serves as the sensing electrode cells to define the pitch of the sensing members. Meanwhile, the corresponding sensing circuit is formed under each sensing electrode so that the monolithic design is formed. In such a monolithic design, however, the sensing surface of the area sensor is equal to the area of the sensing array. For example, if the sensing array has 100×100 sensing members, then the sensing surface area is equal to about 5 mm×5 mm. If the areas of the peripheral analog and digital circuits are also considered, then the overall area of the fingerprint sensor or chip would be very large, so that the cost is relatively high.

Thus, it is an issue of the invention to decrease the area of the sensing circuit but still to keep the large equivalent sensing area.

### SUMMARY OF THE INVENTION

It is therefore an object of the invention to provide a sensing device, in which the area of the sensing circuit can be reduced without reducing the sensing surface area, and a method of manufacturing the same.

To achieve the above-identified object, the invention provides a sensing device comprising a lower structure, sensing circuit cells, an upper structure, divergent traces and sensing electrode cells. The sensing circuit cells form a sensing circuit cell array and are formed on the lower structure. The upper structure is disposed on the lower structure along a vertical direction. The divergent traces are formed in the upper structure and electrically connected to the sensing circuit cells, respectively. Each of the divergent traces comprises at least one horizontal extending portion and at least one vertical extending portion perpendicular to each other. The sensing electrode cells form a sensing electrode cell array and are formed in the upper structure and electrically connected to the divergent traces, respectively. The sensing electrode cells sense biometrics features of an organism to generate sensing signals. The sensing signals are transmitted to the sensing circuit cells through the divergent traces, respectively, and the sensing circuit cells process the sensing signals to obtain output signals, respectively. A minimum distribution area covering the sensing circuit cells is smaller than or equal to a minimum distribution area covering the sensing electrode cells.

The invention also provides a method of manufacturing a sensing device. The method includes the steps of: forming sensing circuit cells on a lower substrate to obtain a lower structure, the lower structure having exposed lower connection portions; forming divergent traces on an upper substrate to obtain a transitional upper structure, wherein each of the divergent traces comprises at least one horizontal extending portion and at least one vertical extending portion perpendicular to each other, and the transitional upper structure has exposed upper connection portions; placing the lower structure above the transitional upper structure with the lower connection portions and the upper connection portions respectively being aligned with and combined with each other to obtain connection portions; filling an underfill material between the transitional upper structure and the lower structure with the underfill material surrounding the connection portions; using a molding compound layer to fix the transitional upper structure and the lower structure together; removing a portion of the upper substrate until one of the vertical extending portions of the divergent traces is exposed, so that the transitional upper structure becomes an upper structure; and forming sensing electrode cells, electrically connected to the divergent traces, on the upper substrate; and forming a passivation structure on the upper substrate and the sensing electrode cells, wherein the sensing electrode cells sense biometrics features of an organism to generate sensing signals, the sensing signals are transmitted to the sensing circuit cells through the divergent traces, respectively, and the sensing circuit cells process the sensing signals to obtain output signals, respectively, wherein a minimum distribution area covering the sensing circuit cells is smaller than or equal to a minimum distribution area covering the sensing electrode cells.

The invention further provides a method of manufacturing a sensing device. The method comprises the steps of: forming sensing circuit cells on a lower substrate to obtain a lower structure, the lower structure having exposed lower connection portions; forming divergent traces and sensing electrode cells on an upper substrate to obtain a transitional upper structure, wherein each of the divergent traces comprises at least one horizontal extending portion and at least one vertical extending portion perpendicular to each other, the transitional upper structure has exposed upper connection portions, and the sensing electrode cells are electrically connected to the divergent traces, respectively; placing the lower structure above the transitional upper structure with the lower connection portions and the upper connection portions respectively being aligned with and combined with each other to obtain connection portions; filling an underfill material between the transitional upper structure and the lower structure with the underfill material surrounding the connection portions; using a molding compound layer to fix the transitional upper structure and the lower structure together; and removing the upper substrate, wherein the sensing electrode cells sense biometrics features of an organism to generate sensing signals, the sensing signals are transmitted to the sensing circuit cells through the divergent traces, respectively, and the sensing circuit cells process the sensing signals to obtain output signals, respectively, wherein a minimum distribution area covering the sensing circuit cells is smaller than or equal to a minimum distribution area covering the sensing electrode cells.

The invention further provides a method of manufacturing a sensing device. The method comprises the steps of: forming sensing circuit cells, arranged in a sensing circuit cell array, on a lower substrate to obtain a lower structure, the lower structure having exposed lower connection portions; placing a plurality of the lower structures on a package substrate; using a molding compound layer to fix the lower structure and the lower substrate together with the molding compound layer covering the lower connection portions; removing a portion of the molding compound layer to expose the lower connection portions; and forming divergent traces and sensing electrode cells, arranged in a sensing electrode cell array, on the molding compound layer to obtain upper structures, wherein each of the divergent traces comprises at least one horizontal extending portion and at least one vertical extending portion perpendicular to each other, and the divergent traces electrically connect the sensing electrode cells to the lower connection portions, respectively, wherein the sensing electrode cells sense biometrics features of an organism to generate sensing signals, the sensing signals are transmitted to the sensing circuit cells through the divergent traces, respectively, and the sensing circuit cells process the sensing signals to obtain output signals, respectively, wherein a minimum distribution area covering the sensing circuit cells is smaller than or equal to a minimum distribution area covering the sensing electrode cells.

According to the above-mentioned aspects, the pitch of the sensing circuit cells can be decreased without decreasing the pitch of the fingerprint sensing members, so that the area used by the chip of the sensing circuit can be decreased, and the cost of the sensing device can be thus decreased.

Further scope of the applicability of the present invention will become apparent from the detailed description given hereinafter. However, it should be understood that the detailed description and specific examples, while indicating preferred embodiments of the present invention, are given by way of illustration only, since various changes and modifications within the spirit and scope of the present invention will become apparent to those skilled in the art from this detailed description.

### BRIEF DESCRIPTION OF THE DRAWINGS

The present invention will become more fully understood from the detailed description given hereinbelow and the accompanying drawings which are given by way of illustration only, and thus are not limitative of the present invention.

FIG. 1 is a partially pictorial exploded view showing a sensing device according to a first embodiment of the invention.

FIGS. 2A and 2B are partial cross-sectional views showing two examples of the sensing device according to the first embodiment of the invention.

FIGS. 3A to 3J show structures in various steps of the method of manufacturing the sensing device according to the first embodiment of the invention.

FIGS. 3K to 3N show structures in various steps of the method of manufacturing the sensing electrode cells according to an example of the first embodiment of the invention.

FIG. 4 is a partially pictorial exploded view showing a sensing device according to a second embodiment of the invention.

FIG. 5 is a partial cross-sectional view showing the sensing device according to the second embodiment of the invention.

FIGS. 6A to 6D show structures in various steps of the method of manufacturing the sensing device according to the second embodiment of the invention.

FIG. 7A is a partially pictorial exploded view showing a sensing device according to a third embodiment of the invention.

FIG. 7B is a partially pictorially assembled view showing the sensing device according to the third embodiment of the invention.

FIG. 7C is a fully pictorially assembled view showing the sensing device according to the third embodiment of the invention.

FIGS. 8A to 8E show structures in various steps of the method of manufacturing a sensing device according to a fourth embodiment of the invention.

FIG. 9A is a top view showing an electronic apparatus installed with the sensing device.

FIGS. 9B and 9C are two examples showing installation positions of the sensing device.

### DETAILED DESCRIPTION OF THE INVENTION

The present invention will be apparent from the following detailed description, which proceeds with reference to the accompanying drawings, wherein the same references relate to the same elements.

The main idea of the invention regards how to save the area of the integrated circuit (IC) covering the sensing circuits and the associated peripheral processing circuits so that the cost of the area-type fingerprint sensing device can be decreased. The innovation of the invention is to divide the sensing device into a sensing circuit cell array (comprising the associated peripheral processing circuits to become a monolithic type IC) and a sensing electrode cell array, which is actually in contact with, for example, finger skin, and the two arrays are manufactured separately. The sensing circuit cell array is manufactured by the complete IC manufacturing processes, the pitch of the sensing circuit cells is reduced smaller than 25 microns (um), for example. However, the pitch of the sensing electrode cells is still kept at the original product's specification (e.g., the commercial fingerprint sensing device must have the resolution of at least 500 dpi, which represents that the pitch of the sensing electrode cells is about 50 um). As a result, the area of the sensing circuit cell array of the invention would be only ¼ of that of the sensing electrode cell array. Thus, the cost of the sensing IC can be significantly decreased, and the sensing electrode cell array is only manufactured by the post IC manufacturing process of forming metal wires (two to three layers), and the cost thereof is relatively low. The two portions are assembled using the micro-bump (or ubump) structure to connect the sensing circuit cell with the sensing electrode cell to form the one-to-one correspondence. In order to achieve such effects, the design of the divergent trace, which will be described later, must be applied.

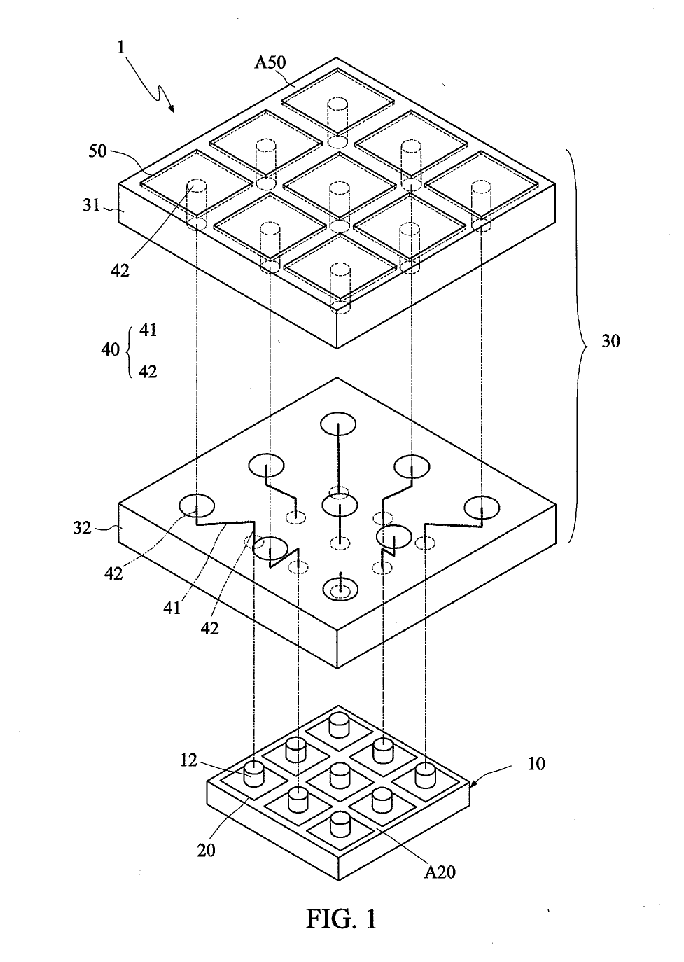

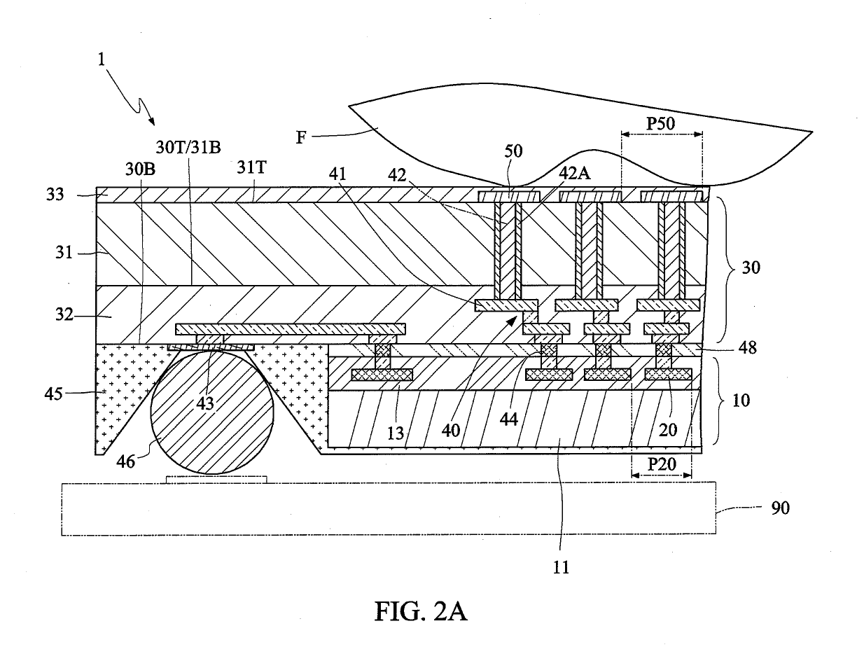

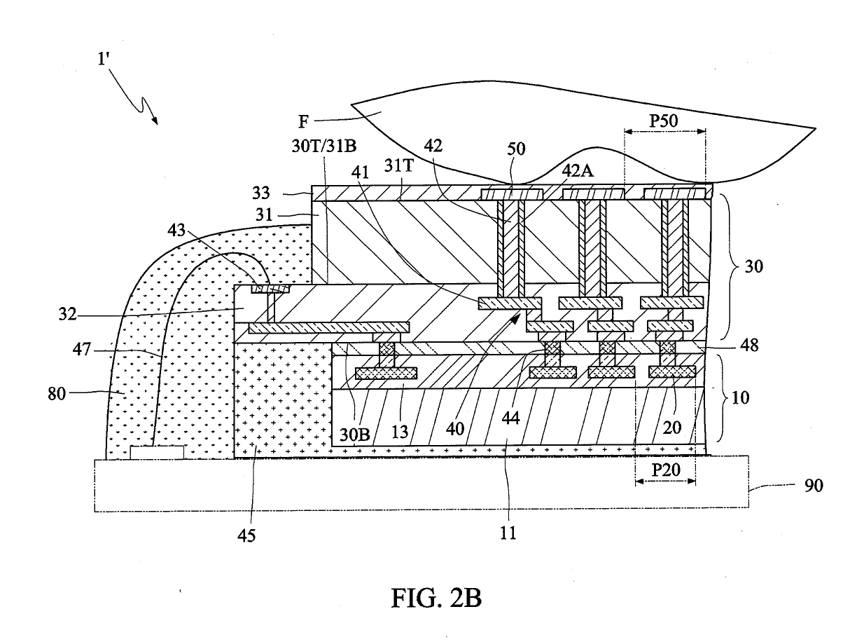

FIG. 1 is a partially pictorial exploded view showing a sensing device 1 according to a first embodiment of the invention. FIGS. 2A and 2B are partial cross-sectional views showing two examples of the sensing device 1 according to the first embodiment of the invention. In this embodiment, a precise interposer is adopted to complete the novel structure of this invention. In this embodiment, the interposer is a silicon interposer. In other embodiment, of course, the interposer may also be made of glass, a ceramics material or any other material. The utilization of the silicon interposer has the great advantage that the advanced progress of the semiconductor manufacturing process can be fully applied.

First, as shown in FIGS. 1 and 2A, this embodiment provides the sensing device 1 comprising a lower structure 10, sensing circuit cells 20 arranged in and constituting a sensing circuit cell array, an upper structure 30, divergent traces 40 and sensing electrode cells 50. The pitch of the sensing electrode cells 50 ranges from about 25 to about 80 microns.

In one example, the lower structure 10 is formed by performing semiconductor manufacturing processes to form the sensing circuit cells 20 on a lower substrate (particularly a semiconductor substrate, more particularly a silicon substrate) 11. Thus, the sensing circuit cells 20 are formed in the lower structure 10. Because the lower structure 10 is formed with integrated circuits, such as sensing circuit cells, it is also referred to as a lower sensing IC structure.

The upper structure 30 is disposed on the lower structure 10 along a vertical direction and serves as a precise silicon interposer. The upper structure 30 has no active device (MOS transistor, diode or the like) formed, but may be selectively formed with passive devices, such as resistors, capacitors, inductors or the like. The upper structure 30 comprises an upper substrate 31, a dielectric structure (may have a single-layer or multi-layer material) 32 and a passivation structure 33. In one example, the upper substrate 31 is composed of silicon. It is to be noted that in this embodiment, the dielectric structure 32 is formed on the upper substrate 31 using, for example, the standard semiconductor thin film deposition and photo lithography, but not by way of assembling. So, the pictorial view of FIG. 1 is provided only for the purpose of clearly showing the divergent traces 40. The dielectric structure 32 is disposed on a lower surface 31B of the upper substrate 31, and surrounds the divergent traces 40 to protect and support the divergent traces 40. The passivation structure 33 is disposed on an upper surface 31T of the upper substrate 31, and surrounds the sensing electrode cells 50. The passivation structure 33 for protecting the sensing electrode cells 50 may be composed of an ordinary dielectric material (e.g., silicon dioxide, silicon nitride or the like), and may further comprise a hydrophobic and lipophobic material, ceramics material (e.g., aluminum oxide or the like) with the high dielectric coefficient, or the combination of multi-layer materials.

The divergent traces 40 are formed in the upper structure 30 and are electrically connected to the sensing circuit cells 20, respectively. Each divergent trace 40 comprises at least one horizontal extending portion 41 and at least one vertical extending portion 42 perpendicular to each other. Preferably, at least two horizontal extending portions 41 and at least two vertical extending portions 42 are provided. The vertical extending portion 42 comprises a through-silicon via (TSV), wherein an insulating layer 42A is present between the TSV and the upper substrate 31, so that the TSV and the silicon substrate are electrically isolated from each other. It is to be noted that the topmost vertical extending portion 42 of the divergent trace 40 of this embodiment is TSV conductor, and corresponding other layout traces other than the TSV are substantially composed of metal wires and via metals between metal wires, which are formed by the back-end semiconductor manufacturing process. The dielectric structure 32 supports and protects these via metals and metal wires, wherein the associated material and the manufacturing method of the layout traces are well known in the art, and will not be described herein. In addition, the signal transmission direction of the horizontal extending portion 41 is along a horizontal direction, and the signal transmission direction of the vertical extending portion 42 is along a vertical direction. In addition, the TSVs and the divergent traces are the media for connecting the sensing electrode cells 50 to the sensing circuit cells 20, and are provided for the purpose of sensing signal transmission, but are not provided for the purpose of connecting the solder balls or being bonded to the printed circuit board (PCB) for the signal output, as being used in the prior art for IC package. Furthermore, the connection between the lower structure 10 and the upper structure 30 is formed with connection portions 44 by way of micro-bump bonding, and an underfill material 48 may or may not be used to fill between the lower structure 10 and the upper structure 30 to cover and support the connection portions 44.

The sensing electrode cells 50 are formed in the upper structure 30, and are electrically connected to the divergent traces 40, correspondingly. The sensing electrode cells 50 senses a fingerprint of a finger F to generate sensing signals, which are transmitted to the sensing circuit cells 20 through the divergent traces 40, accordingly. The sensing circuit cells 20 process the sensing signals to obtain output signals, respectively. In addition to the sensing of the fingerprint of the finger F, the sensing device of the invention may also sense the electrical signal, generated when being in contact with the organism. For example, the sensing device may function as a touch switch or may sense the skin's humidity, the skin's temperature, the blood information under the skin, the vein distribution pattern under the skin, or the like. That is, the sensing electrode cells 50 of the invention can sense the biometrics features of the organism. The biometrics features are preferably unique to the person (single-finger or multi-finger touch are not unique to the person). However, the invention is not particularly restricted thereto. Due to the special configuration of the divergent trace 40, a minimum distribution area A20 (or referred to as a minimum distribution area of the sensing circuit cell array) covering the sensing circuit cells 20 is smaller than or equal to a minimum distribution area A50 (or referred to as a minimum distribution area of the sensing electrode cell array) covering the sensing electrode cells 50. For example, a pitch P20 of the sensing circuit cells 20 is smaller than a pitch P50 of the sensing electrode cells 50. Because the line width and the line spacing of metal interconnects used in the current silicon interposer match with those used in the semiconductor manufacturing processes (the current semiconductor manufacturing process can provide the manufacturing process of 20 nm or less), the invention also utilizes the very fine conductor interconnects to diverge the small-area sensing circuit cell array into the large-area sensing electrode cell array. So, there is no problem to utilize the TSV of the interposer as the extension of the core integrated circuit (IC) block (sensing circuit cell 20).

In addition, in order to output the output signal, the sensing device 1 may further include output bonding pads 43, a molding compound layer 45 and a circuit board 90.

The output bonding pads 43 are formed on a surface 30B of the upper structure 30, and are electrically connected to the sensing circuit cells 20 to output the output signals, respectively. The molding compound layer 45 covers the upper structure 30 and the lower structure 10 to provide the fixing effect. The output bonding pad 43 may also be implemented in other ways to be described later. The circuit board 90 is electrically connected to the output bonding pads 43. In the example of FIG. 2A, the output bonding pads 43 are bonded to the circuit board 90 through solder balls 46.

In the example of the sensing device 1′ of FIG. 2B, the output bonding pads 43 are bonded to the circuit board 90 through wires 47. Then, a glue layer 80 encapsulates and seals the wires 47 and the output bonding pads 43.

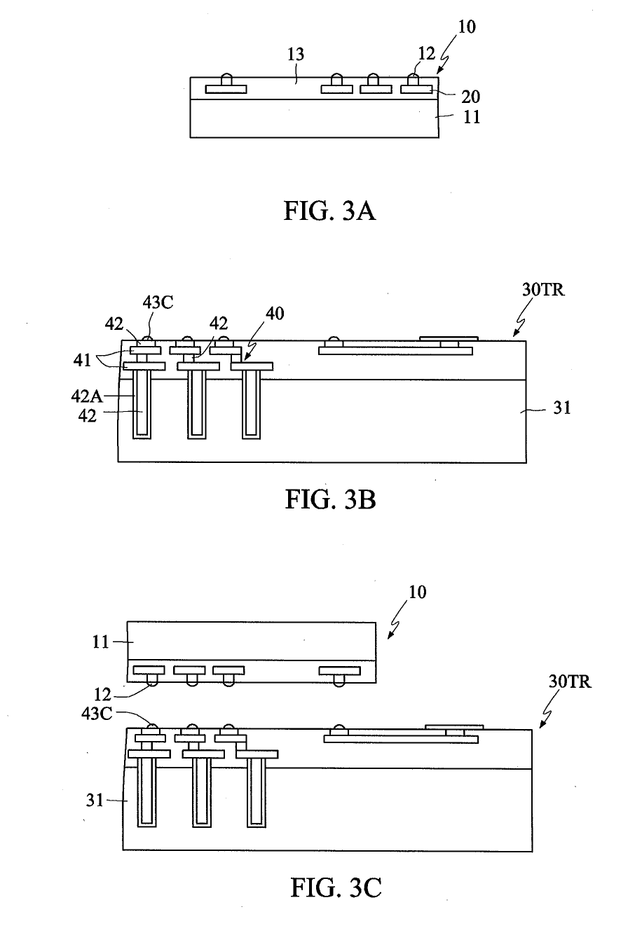

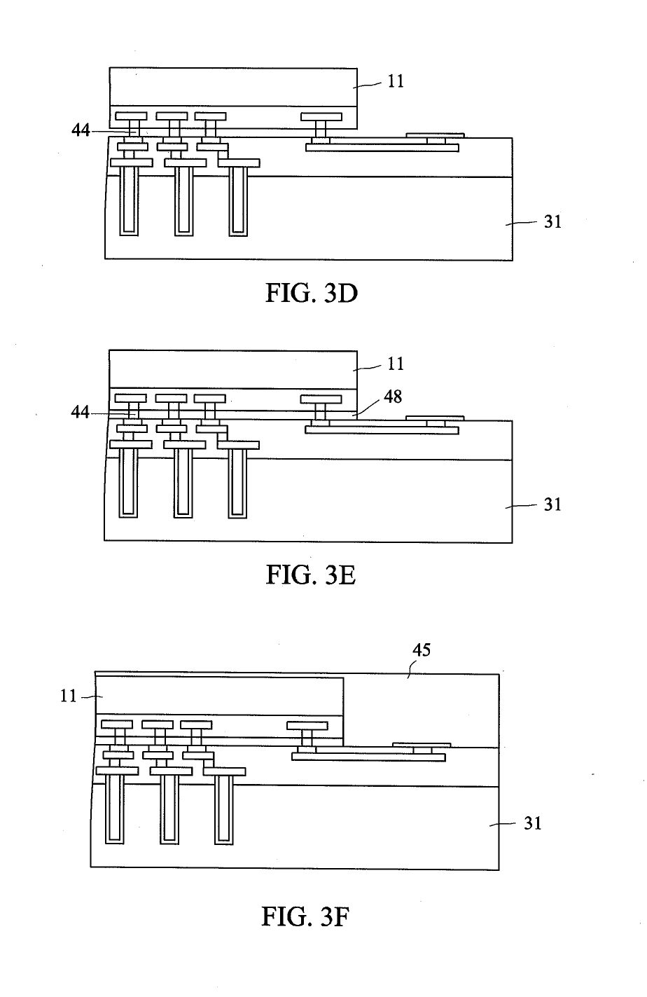

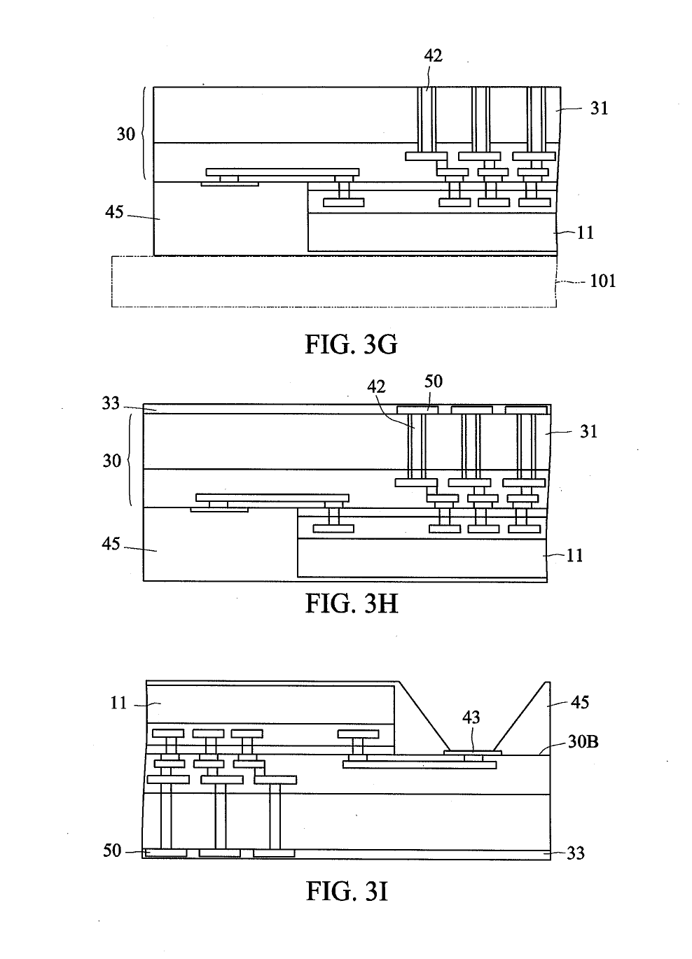

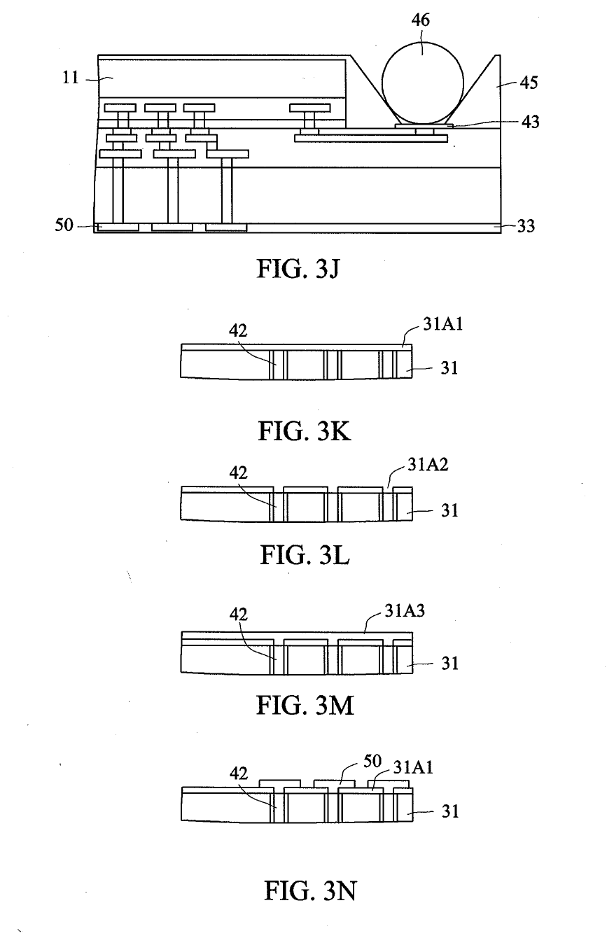

FIGS. 3A to 3J show structures in various steps of the method of manufacturing the sensing device 1 according to the first embodiment of the invention. First, as shown in FIG. 3A, the sensing circuit cells 20 are formed on a lower substrate 11 to obtain the lower structure 10, which has the exposed lower connection portions 12. The lower substrate 11 is, for example, a semiconductor substrate, particularly a silicon substrate, wherein semiconductor manufacturing processes are performed to form the sensing circuit cells 20 and a dielectric material 13 surrounding the sensing circuit cell 20 on the silicon substrate. The sensing circuit cell may comprise an active device or active devices disposed in the silicon substrate, and trace elements connected to the active devices. Of course, in order to simplify the description, only the core sensing circuit cell array of the sensing circuit cells 20 is depicted. However, those skilled in the art may understand that the sensing circuit cell array is one portion of a sensing IC, and the IC may further comprise associated analog and digital circuits. Next, as shown in FIG. 3B, one set of divergent traces 40 is formed on the upper substrate 31 to obtain a transitional upper structure 30TR, wherein each of the divergent traces 40 comprises the horizontal extending portion 41 and the vertical extending portion 42 perpendicular to each other, and the transitional upper structure 30TR has exposed upper connection portions 43C. The vertical extending portion 42 pertaining to the TSV may be formed by etching a trench, forming an insulating layer on the trench, forming a metal layer on the insulating layer, and performing plating using the metal layer (e.g., a copper layer) as a seed layer, so that the TSV is formed. It is to be particularly noted that the method of manufacturing the upper substrate 31 of the invention utilizes the complete wafer manufacturing processes. That is, an 8-inch or 12-inch wafer may be used to perform the manufacturing process with the optimum cost effectiveness when the optimum cost is considered. However, the wafer size is not particularly restricted thereto.

Then, as shown in FIGS. 3C and 3D, the lower structure 10 is placed above the transitional upper structure 30TR with the lower connection portions 12 and the upper connection portions 43C being accordingly aligned with and combined with each other to obtain the connection portions 44. It is to be noted that multiple lower structures 10 may be formed. Multiple chip-level lower structures 10 arranged in an array and the wafer-level transitional upper structure 30TR are used to perform the mass production by way of chip on wafer (COW). In addition, the lower connection portion 12 and/or the upper connection portion 43C may be implemented by micro-bumps. The micro-bump may also be a solder bump, a copper bump or any other metal bump, such as the bump composed of gold, silver, nickel, tungsten, aluminum or an alloy thereof. The lower connection portion 12 may be bonded to the upper connection portion 43C by solder or direct metal-metal (e.g., copper-copper) diffusion bonding. Taking the solder bump as an example, a dielectric structure may be formed on the exposed metal, then openings are defined on the dielectric structure to expose connection pads, then a copper seed layer is formed on the connection pads and the dielectric structure, then a photoresist layer is formed on the copper seed layer, then an opening or openings are defined on the photoresist layer, and then the plating process is performed to form the copper layer. Thereafter, solder caps are formed on the copper layer, and then the photoresist layer is removed and the reflow is performed to form the micro-bumps.

Next, as shown in FIG. 3E, the underfill material 48 is filled between the transitional upper structure 30TR and the lower structure 10 with the underfill material 48 surrounding the connection portions 44.

Then, as shown in FIG. 3F, the molding compound layer 45 is used to fix the transitional upper structure 30TR and the lower structure 10 together. Such as process can fill the molding compound between the neighboring lower structures 10 in the COW technology, so that the subsequent die sawing or cutting processes are facilitated.

Next, as shown in FIG. 3G, a portion of the upper substrate 31 is removed until one of the vertical extending portions 42 of the divergent traces 40 is exposed, so that the transitional upper structure 30TR becomes the upper structure 30. For example, an adhesive carrier 101 is adhered to the molding compound layer 45, and then a portion of the upper substrate 31 is ground until the TSV is exposed. Next, the adhesive carrier 101 is removed.

Then, as shown in FIG. 3H, multiple sensing electrode cells 50, electrically connected to the divergent traces 40, are formed on the upper substrate 31, and the passivation structure 33 is formed on the upper substrate 31 and the sensing electrode cells 50. The sensing electrode cell 50 functions as the sensing member for sensing the fingerprint of the finger F by way of, for example, the capacitive/electric field/thermal sensing/pressure sensing principle, to generate the sensing signals. The sensing signals are transmitted to the sensing circuit cells 20 through the divergent traces 40, respectively. The sensing circuit cells 20 process the sensing signals to obtain output signals, respectively. Because divergence from the sensing circuit cell 20 to the sensing electrode cell 50 can be achieved, the minimum distribution area covering the sensing circuit cells 20 is smaller than or equal to the minimum distribution area covering the sensing electrode cells 50. One example regarding the details of the formation of sensing electrode cell 50 will be described later.

In order to extract the signal of the sensing circuit cell 20, various semiconductor manufacturing processes and assembling processes may be adopted. In the following, two exemplified but non-limitative examples will be described.

In order to form the sensing device 1 of FIG. 2A, the manufacturing method may further comprise the following steps. First, as shown in FIG. 3I, a portion of the molding compound layer 45 is removed to expose the output bonding pads 43 formed on the surface 30B of the upper structure 30. In one example, the laser may be utilized to remove a portion of the molding compound layer 45. Next, as shown in FIG. 3J, the solder balls 46 are formed on the output bonding pads 43, and then the reflow technology is performed to bond the output bonding pads 43 to the circuit board 90 (see FIG. 2A). The circuit board 90 has at least one conductor layer, which is mainly for coupling the sensing signals to another electronic device (e.g., the processor of the mobile phone), which also controls the operation of the sensing device 1.

In order to form the sensing device 1′ of FIG. 2B, the manufacturing method may further comprise the following steps. Referring to FIG. 2B first, a portion of the upper substrate 31 is removed to expose the output bonding pads 43 formed on the surface 30T of the upper structure 30. Then, the molding compound layer 45 is placed on the circuit board 90. Next, multiple wires 47 are used to connect the output bonding pads 43 to the circuit board 90. Because this pertains to the standard package manufacturing process, detailed descriptions thereof will be omitted.

FIGS. 3K to 3N show structures in various steps of the method of manufacturing the sensing electrode cells according to an example of the first embodiment of the invention. In one exemplified but non-limitative example, the sensing electrode cell 50 may be formed by the following method. First, as shown in FIG. 3K, after the TSVs (vertical extending portions 42) are exposed, an insulating layer (e.g., silicon dioxide or silicon nitride layer) 31A1 is formed on the upper substrate 31. Next, as shown in FIG. 3L, the photo lithography is adopted to form electrical connection openings 31A2 on the TSVs. Then, as shown in FIG. 3M, a metal layer 31A3 is formed on the insulating layer 31A1 and the TSVs. Next, as shown in FIG. 3N, the photo lithography is adopted to define multiple sensing electrode cells 50, electrically connected to the TSVs, on the metal layer 31A3. In this embodiment, the insulating layer 31A1 may be regarded as one portion of the upper structure 30. The sensing electrode cells 50 are directly formed above the TSVs. Of course, the invention is not particularly restricted thereto, and any other technology, such as adhering, bonding or the like, may be adopted to manufacture the sensing electrode cells 50.

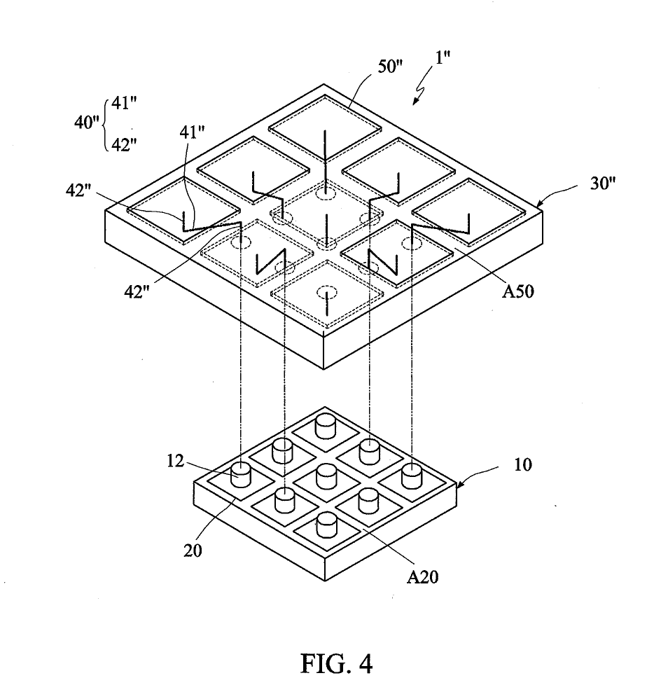

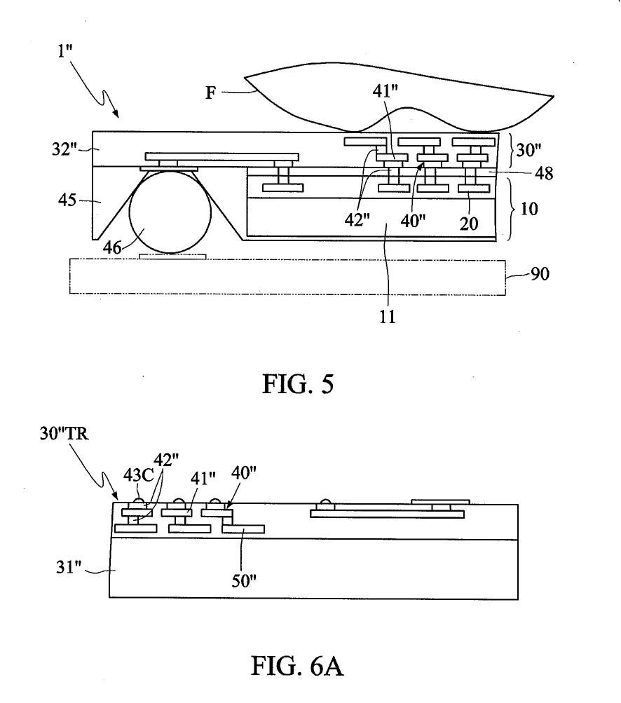

FIG. 4 is a partially pictorial exploded view showing a sensing device sensing device 1″ according to a second embodiment of the invention. FIG. 5 is a partial cross-sectional view showing the sensing device 1″ according to the second embodiment of the invention. As shown in FIGS. 4 and 5, this embodiment is similar to the first embodiment except for the difference that no TSV is formed in the upper structure 30″ of this embodiment, but the horizontal extending portion of the topmost conductor of the divergent trace 40 of FIG. 2A serves as the sensing electrode cell 50″. Thus, the upper structure 30″ comprises a dielectric structure 32″ surrounding the divergent traces 40″ and the sensing electrode cells 50″. In other words, the divergent traces 40″ of this embodiment are also formed in the upper structure 30″, and electrically connected to the sensing circuit cells 20, respectively. Each divergent trace 40″ comprises at least one horizontal extending portion 41″ and at least one vertical extending portion 42″ perpendicular to each other, and the vertical extending portion 42″ does not contain any TSV. The sensing electrode cells 50″ are formed in the upper structure 30″, and are electrically connected to the divergent traces 40″, respectively.

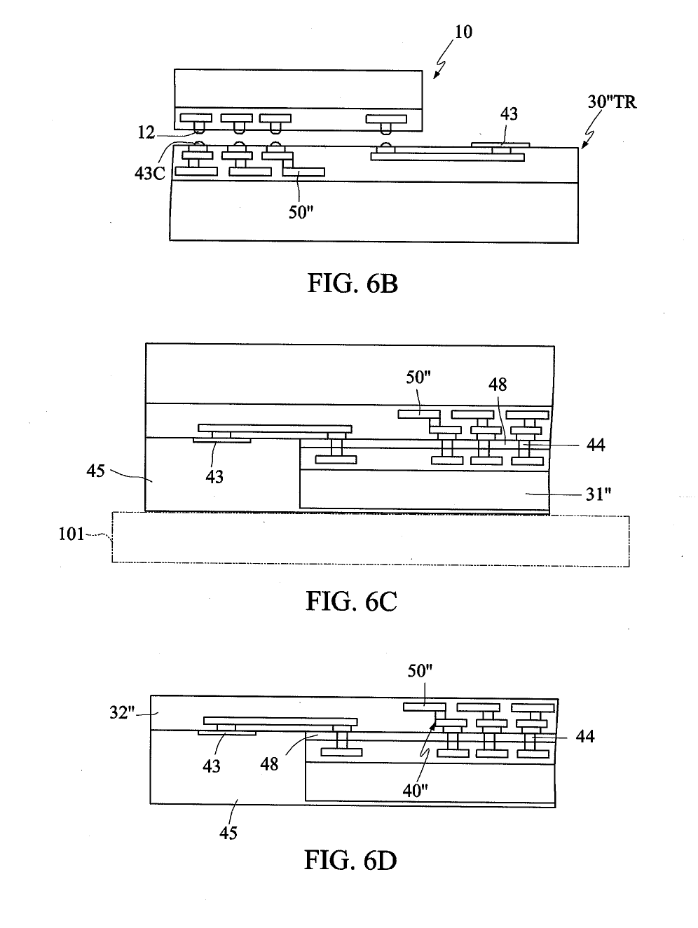

FIGS. 6A to 6D show structures in various steps of the method of manufacturing the sensing device according to the second embodiment of the invention.

First, similar to FIG. 3A, the sensing circuit cells 20 are formed on the lower substrate 11 to obtain the lower structure 10 having exposed lower connection portions 12.

Then, as shown in FIG. 6A, divergent traces 40″ and sensing electrode cells 50″ are formed on an upper substrate 31″ to obtain a transitional upper structure 30″TR, wherein each divergent trace 40″ comprises at least one horizontal extending portion 41″ and at least one vertical extending portion 42″ perpendicular to each other. The transitional upper structure 30″TR has exposed upper connection portions 43C. The sensing electrode cells 50″ are electrically connected to the divergent traces 40″, respectively.

Next, as shown in FIGS. 6B and 6C, the lower structure 10 is placed above the transitional upper structure 30″TR with the lower connection portion 12 and the upper connection portion 43C being respectively aligned with and combined with each other to obtain the connection portions 44. Then, the underfill material 48 is filled between the transitional upper structure 30″TR and the lower structure 10 with the underfill material 48 surrounding the connection portions 44. Thereafter, the molding compound layer 45 is provided to fix the transitional upper structure 30″TR and the lower structure 10 together. Next, the adhesive carrier 101 is adhered to the molding compound layer 45, and the upper substrate 31 is ground to remove the upper substrate 31 until the upper substrate 31 is completely removed. That is, the dielectric structure 32″, and the sensing electrode cells 50″ as well as the divergent traces 40″ in the dielectric structure 32″ are left, so that the structure shown in FIG. 6D is obtained. In addition, at least one passivation structure may also be formed on the dielectric structure 32″, and the material of the passivation structure may be that as mentioned hereinabove.

Of course, in this embodiment, the sensing electrode cells 50″ may also sense the fingerprint of the finger F to generate sensing signals, which are transmitted to the sensing circuit cells 20 through the divergent traces 40″, respectively, wherein the sensing circuit cells 20 process the sensing signals to obtain output signals, respectively, and the minimum distribution area covering the sensing circuit cells 20 is smaller than the minimum distribution area covering the sensing electrode cells 50″. The output connection configuration of the output bonding pads 43 is similar to that of the first embodiment, and detailed descriptions thereof will be omitted.

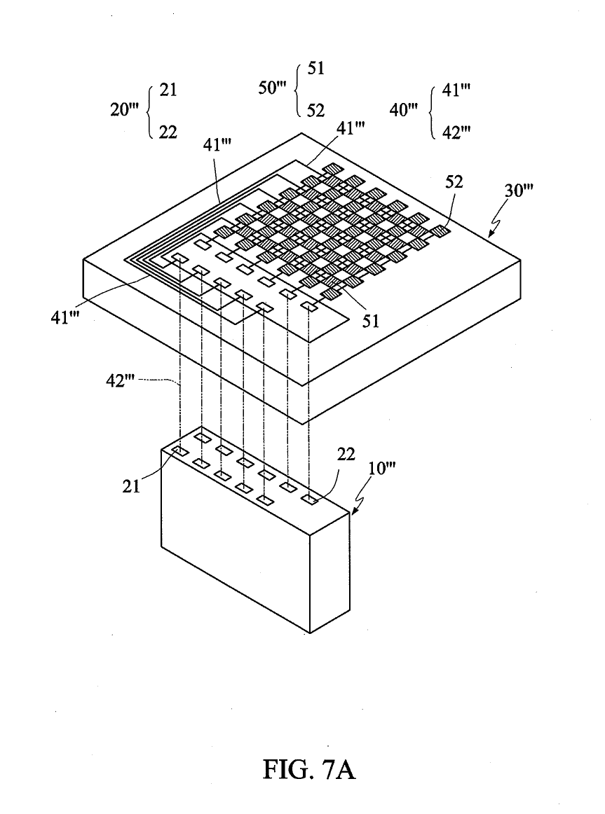

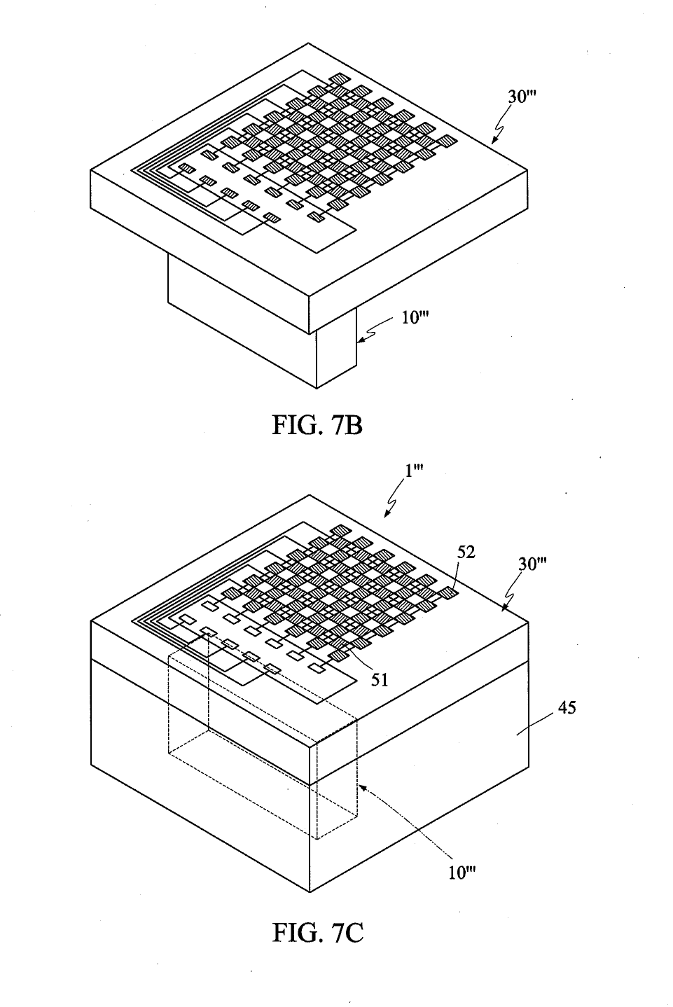

FIGS. 7A, 7B and 7C are a partially pictorial exploded view, a partially pictorially assembled view and a fully pictorially assembled view, respectively, showing a sensing device 1′″ according to a third embodiment of the invention. This embodiment is similar to the second embodiment except for the difference in the layout format. Thus, in the sensing device 1′″ of the third embodiment, the sensing electrode cell array of the sensing electrode cells 50′″ comprises driving electrodes 51, and receiving electrodes 52 perpendicularly interleaving with the driving electrodes 51. For example, such a structure can be implemented using the design of two metal layers. The so-called “perpendicularly interleaving” represents that the wires of the electrodes perpendicularly cross over without electrical connection. In addition, the sensing circuit cell array of the sensing circuit cell 20′″ comprises: driving circuits 21 each being electrically connected to one of the columns of the driving electrodes 51 to perform a scan operation or a driving operation; and receiving circuits 22 each being electrically connected to one of the rows of the receiving electrodes 52 to perform a receiving operation to obtain sensing signals.

The sensing structure of this embodiment is similar to the projected-capacitive touch panel. Although the driving electrodes 51 and the receiving electrodes 52 are arranged in square arrays, the driving electrodes 51 and the receiving electrodes 52 may also be arranged in a rhombus array to increase the fill factor. Unlike the conventional touch panel, the driving electrodes 51 and the receiving electrodes 52 of this embodiment are not covered by a glass layer (about 0.3 to 1 mm), and the thickness of the passivation structure covering the driving electrodes 51 and the receiving electrodes 52 ranges from about 0.1 microns to 60 microns, preferably from 10 to 50 microns, and the resolution of this embodiment is significantly higher than that of the touch panel. The pitch of the sensing members ranges from about 25 to 80 microns, for example, and is preferably about 50 microns, which is also significantly lower than that (6 mm) of the touch panel. The touch panel treats the finger as the single information input, while the invention is to scan the textures of the finger surface. For these reasons, the difficulty of the sensing member structure of the invention is significantly much higher than that of the conventional touch panel. Thus, the conventional projection-type capacitor touch panel cannot achieve the function of sensing the fingerprint, vein distribution patterns and blood components. In addition, this embodiment has the driving circuit 21 and the receiving circuit 22 designed and formed on a single chip. The driving circuit 21 and the receiving circuit 22 are combined into the sensing circuit cell 20′″. The divergent trace 40′″ similarly comprises a horizontal extending portion 41′″ and a vertical extending portion 42′″. In addition, in FIG. 7C, the molding compound layer 45 is also provided to fix the lower structure 10′″ to the upper structure 30′″.

Because the horizontal area of the silicon chip of the lower structure 10′″ does not correspond to the horizontal area of the upper structure 30′″ in a one-to-one (1:1) manner in this embodiment, the silicon chip can be designed to be thin, long and small, and this is advantageous to the reduction of the cost. Furthermore, another difference between this embodiment and the second embodiment resides in that the sensing member array (comprising the driving electrodes 51 and the receiving electrodes 52) is not disposed exactly above the lower structure 10′″.

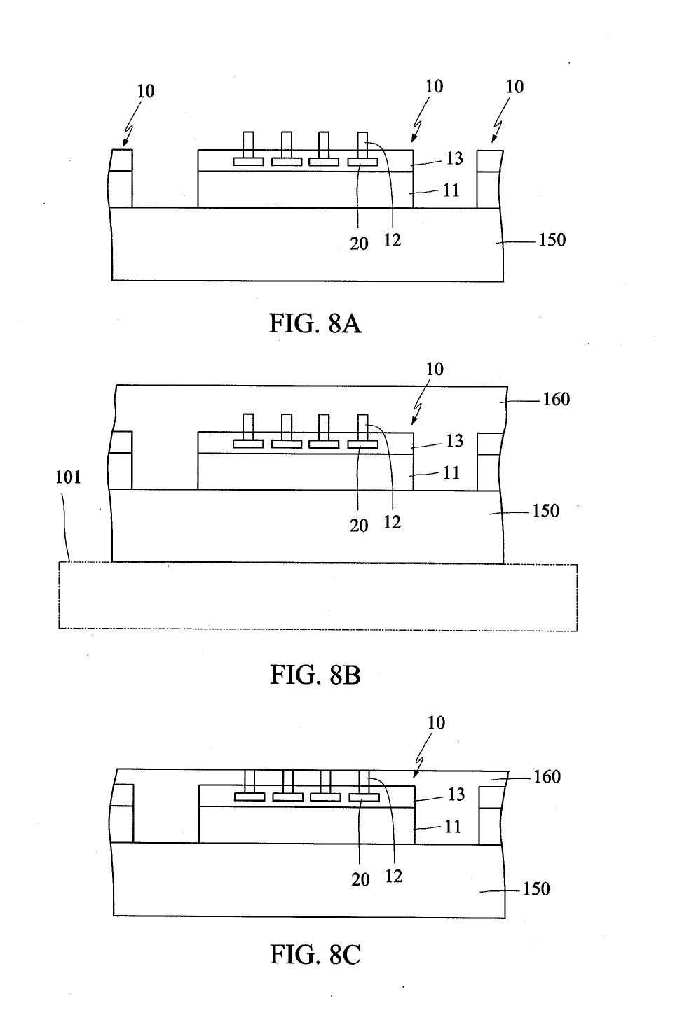

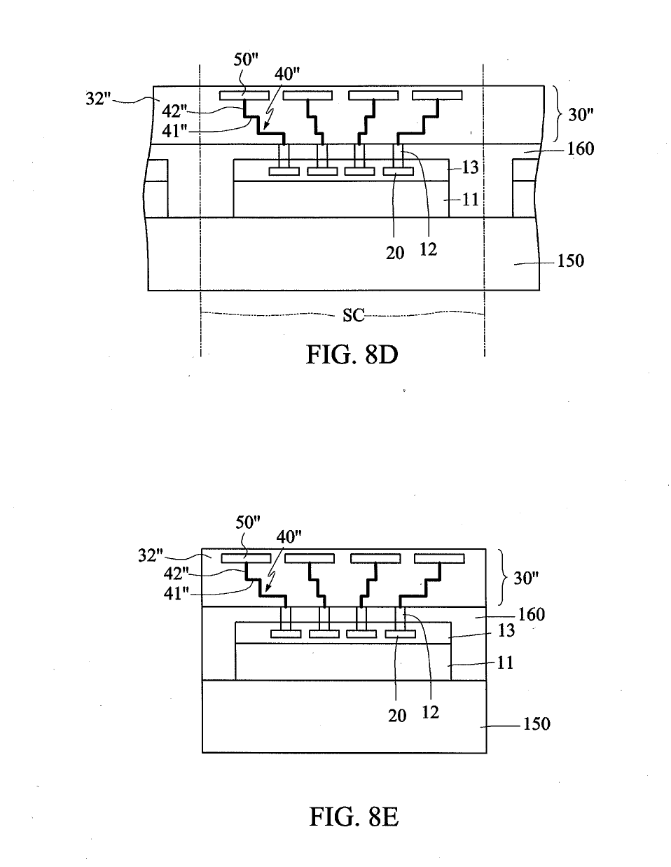

FIGS. 8A to 8E show structures in various steps of the method of manufacturing a sensing device according to a fourth embodiment of the invention. The structure of this embodiment is similar to the second or third embodiment, but is manufactured by different manufacturing methods.

First, as shown in FIG. 8A, the sensing circuit cells 20 are formed on the lower substrate 11 to obtain the lower structure 10, which has the exposed lower connection portions 12. The lower connection portions 12 are connected to the sensing circuit cells 20. The sensing circuit cell 20 and the lower connection portion 12 are surrounded by the dielectric material 13. Multiple lower structures 10 may be formed on a wafer at a time, and then a die sawing process is performed to obtain multiple separated lower structures 10. This structure can be easily formed using a typical semiconductor manufacturing process, so detailed descriptions thereof will be omitted. Next, the lower structures 10 are placed on a wafer-level package substrate (e.g., silicon substrate, glass substrate, or the like) 150. Then, as shown in FIG. 8B, a molding compound layer 160 is provided to fix the lower structure 10 and the lower substrate 11 together, and the molding compound layer 160 covers the lower connection portions 12. Next, an adhesive carrier 101 is adhered to a package substrate 150. Then, a portion of the molding compound layer 160 is removed by performing a grinding process, for example, to expose the lower connection portions 12, as shown in FIG. 8C. Next, the divergent traces 40″ and the sensing electrode cells 50″ are formed on the molding compound layer 160 to obtain the upper structures 30″, as shown in FIG. 8D. The divergent traces may be formed by forming a metal layer on the molding compound layer 160, patterning the metal layer, and establishing multi-layer connections. In this embodiment, the divergent traces are formed by the technology similar to that of the multi-layer coating and dielectric layer material forming. The upper structure 30″ comprises a dielectric structure 32″ surrounding the divergent traces 40″ and the sensing electrode cells 50″. The dielectric structure 32″ may comprise an intermetal dielectric structure and a passivation structure. The passivation structure provides the uppermost surface to protect the sensing electrode cell 50″. Next, cutting processes are performed along scribing lines SC to obtain multiple sensing devices, as shown in FIG. 8E. In this embodiment, each divergent trace 40″ comprises at least one horizontal extending portion 41″ and at least one vertical extending portion 42″ perpendicular to each other. The divergent traces 40″ electrically connect the sensing electrode cells 50″ to the lower connection portions 12, respectively. The sensing electrode cells 50″ can sense the fingerprint of the finger F to generate sensing signals, which are transmitted to the sensing circuit cells 20 through the divergent traces 40″, respectively. The sensing circuit cells 20 process the sensing signals to obtain output signals, respectively. Similar to the above-mentioned embodiment, the minimum distribution area covering the sensing circuit cells 20 is smaller than or equal to the minimum distribution area covering the sensing electrode cells 50″.

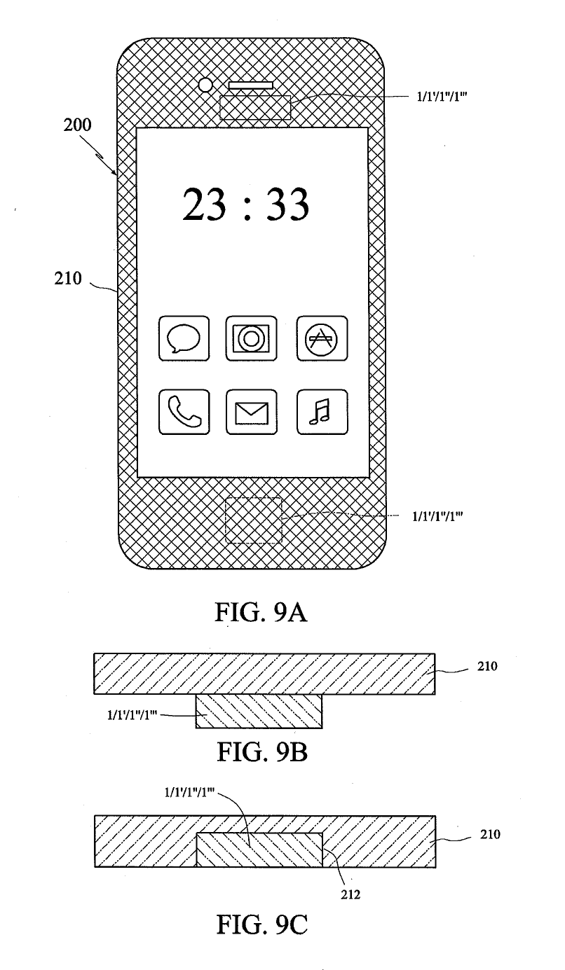

FIG. 9A is a top view showing an electronic apparatus installed with the sensing device. FIGS. 9B and 9C are two examples showing installation positions of the sensing device. As shown in FIG. 9A, the sensing device 1/1′/1″/1′″ of the above-mentioned embodiment can be disposed under or below the panel of the mobile phone, for example. Because the user puts great emphasis on the outlook of the mobile phone, the key point of the design of this invention is to hide the sensing device below the panel 210. Thus, the sensing device must have a fully flat design. According to the sensing device of the invention, the area-type or sweep-type fingerprint sensing device can be implemented, and the device is mounted on the lower surface (FIG. 9B) of the panel 210 or a cavity 212 (FIG. 9C) of the panel 210, so that the panel 210 has the touch, display and fingerprint sensing functions.

According to the above-mentioned embodiments, the pitch of the sensing circuit cells can be decreased without decreasing the pitch of the fingerprint sensing members, so that the area used by the chip of the sensing circuit can be decreased, and the cost of the sensing device can be thus decreased.

While the present invention has been described by way of examples and in terms of preferred embodiments, it is to be understood that the present invention is not limited thereto. To the contrary, it is intended to cover various modifications. Therefore, the scope of the appended claims should be accorded the broadest interpretation so as to encompass all such modifications.

What is claimed is:

1. A sensing device, comprising:
a lower structure;
sensing circuit cells, which form a sensing circuit cell array and are formed on the lower structure;
an upper structure disposed on the lower structure along a vertical direction;
divergent traces, which are formed in the upper structure and electrically connected to the sensing circuit cells, respectively, wherein each of the divergent traces comprises at least one horizontal extending portion and at least one vertical extending portion perpendicular to each other; and
sensing electrode cells, which form a sensing electrode cell array and are formed in the upper structure and electrically connected to the divergent traces correspondingly, wherein the sensing electrode cells sense biometrics features of an organism to generate sensing signals, the sensing signals are transmitted to the sensing circuit cells through the divergent traces accordingly, and the sensing circuit cells process the sensing signals to obtain output signals, respectively, wherein a minimum distribution area covering the sensing circuit cells is smaller than or equal to a minimum distribution area covering the sensing electrode cells.

2. The sensing device according to claim 1, further comprising:
output bonding pads, which are formed on a surface of the upper structure, electrically connected to the sensing circuit cells, respectively, and for outputting the output signals;
a molding compound layer covering the upper structure and the lower structure; and
a circuit board electrically connected to the output bonding pads.

3. The sensing device according to claim 2, wherein the output bonding pads are bonded to the circuit board through solder balls.

4. The sensing device according to claim 2, wherein the output bonding pads are bonded to the circuit board through wires.

5. The sensing device according to claim 1, wherein a pitch of the sensing circuit cells is smaller than or equal to a pitch of the sensing electrode cells.

6. The sensing device according to claim 1, wherein the upper structure has no active device formed, and the at least one vertical extending portion comprises a through-silicon via (TSV).

7. The sensing device according to claim 1, wherein the upper structure has no active device formed, and the at least one vertical extending portion has no through-silicon via (TSV).

8. The sensing device according to claim 1, wherein the upper structure comprises:
an upper substrate;
a dielectric structure, which is disposed on a lower surface of the upper substrate, and surrounds the divergent traces; and
a passivation structure, which is disposed on an upper surface of the upper substrate, and surrounds the sensing electrode cells.

9. The sensing device according to claim 1, wherein the upper structure comprises:
a dielectric structure, which surrounds the divergent traces and the sensing electrode cells.

10. The sensing device according to claim 1, wherein:
the sensing electrode cell array comprises:
driving electrodes; and
receiving electrodes perpendicularly interleaving with the driving electrodes; and
the sensing circuit cell array comprises:
driving circuits, each of which is electrically connected to one of columns of the driving electrodes to perform a scan operation; and
receiving circuits, each of which is electrically connected to one of rows of the receiving electrodes to perform a receiving operation and obtain the sensing signals.

11. A method of manufacturing a sensing device, comprising the steps of:
(a) forming sensing circuit cells on a lower substrate to obtain a lower structure, the lower structure having exposed lower connection portions;
(b) forming divergent traces on an upper substrate to obtain a transitional upper structure, wherein each of the divergent traces comprises at least one horizontal extending portion and at least one vertical extending portion perpendicular to each other, and the transitional upper structure has exposed upper connection portions;
(c) placing the lower structure above the transitional upper structure with the lower connection portions and the upper connection portions respectively being aligned with and combined with each other to obtain connection portions;
(d) filling an underfill material between the transitional upper structure and the lower structure with the underfill material surrounding the connection portions;
(e) using a molding compound layer to fix the transitional upper structure and the lower structure together;
(f) removing a portion of the upper substrate until one of the vertical extending portions of the divergent traces is exposed, so that the transitional upper structure becomes an upper structure; and
(g) forming sensing electrode cells, electrically connected to the divergent traces, on the upper substrate, and forming a passivation structure on the upper substrate and the sensing electrode cells, wherein the sensing electrode cells sense biometrics features of an organism to generate sensing signals, the sensing signals are transmitted to the sensing circuit cells through the divergent traces, respectively, and the sensing circuit cells process the sensing signals to obtain output signals, respectively, wherein a minimum distribution area covering the sensing circuit cells is smaller than or equal to a minimum distribution area covering the sensing electrode cells.

12. The method according to claim 11, wherein the step (f) comprises:
(f1) adhering an adhesive carrier to the molding compound layer; and
(f2) grinding a portion of the upper substrate.

13. The method according to claim 11, further comprising the steps of:
(h) removing a portion of the molding compound layer to expose output bonding pads, formed on a surface of the upper structure;
(i) forming solder balls onto the output bonding pads; and
(j) bonding the output bonding pads to a circuit board.

14. The method according to claim 11, further comprising the steps of:
(h) removing a portion of the upper substrate to expose output bonding pads, formed on a surface of the upper structure;
(i) placing the molding compound layer on a circuit board; and
(j) using wires to connect the output bonding pads to the circuit board.

15. A method of manufacturing a sensing device, comprising the steps of:
(a) forming sensing circuit cells on a lower substrate to obtain a lower structure, the lower structure having exposed lower connection portions;
(b) forming divergent traces and sensing electrode cells on an upper substrate to obtain a transitional upper structure, wherein each of the divergent traces comprises at least one horizontal extending portion and at least one vertical extending portion perpendicular to each other, the transitional upper structure has exposed upper connection portions, and the sensing electrode cells are electrically connected to the divergent traces, respectively;
(c) placing the lower structure above the transitional upper structure with the lower connection portions and the upper connection portions respectively being aligned with and combined with each other to obtain connection portions;
(d) filling an underfill material between the transitional upper structure and the lower structure with the underfill material surrounding the connection portions;
(e) using a molding compound layer to fix the transitional upper structure and the lower structure together; and
(f) removing the upper substrate, wherein the sensing electrode cells sense biometrics features of an organism to generate sensing signals, the sensing signals are transmitted to the sensing circuit cells through the divergent traces, respectively, and the sensing circuit cells process the sensing signals to obtain output signals, respectively, wherein a minimum distribution area covering the sensing circuit cells is smaller than or equal to a minimum distribution area covering the sensing electrode cells.

16. The method according to claim 15, wherein the step (f) comprises:
(f1) adhering an adhesive carrier to the molding compound layer; and
(f2) grinding the upper substrate.

17. A method of manufacturing a sensing device, comprises the steps of:
(a) forming sensing circuit cells, arranged in a sensing circuit cell array, on a lower substrate to obtain a lower structure, the lower structure having exposed lower connection portions;
(b) placing a plurality of the lower structures on a package substrate;
(c) using a molding compound layer to fix the lower structure and the lower substrate together with the molding compound layer covering the lower connection portions;
(d) removing a portion of the molding compound layer to expose the lower connection portions; and
(e) forming divergent traces and sensing electrode cells, arranged in a sensing electrode cell array, on the molding compound layer to obtain upper structures, wherein each of the divergent traces comprises at least one horizontal extending portion and at least one vertical extending portion perpendicular to each other, and the divergent traces electrically connect the sensing electrode cells to the lower connection portions, respectively, wherein the sensing electrode cells sense biometrics features of an organism to generate sensing signals, the sensing signals are transmitted to the sensing circuit cells through the divergent traces, respectively, and the sensing circuit cells process the sensing signals to obtain output signals, respectively, wherein a minimum distribution area covering the sensing circuit cells is smaller than or equal to a minimum distribution area covering the sensing electrode cells.

18. The method according to claim 17, wherein:
the sensing electrode cell array comprises:
driving electrodes; and
receiving electrodes perpendicularly interleaving with the driving electrodes; and
the sensing circuit cell array comprises:
driving circuits, each of which is electrically connected to one of columns of the driving electrodes to perform a scan operation; and
receiving circuits, each of which is electrically connected to one of rows of the receiving electrodes to perform a receiving operation to obtain the sensing signals.
